(19) United States
(12) Patent Application Publication
(10) Pub. No.: US 2010/0049587 A1
(43) Pub. Date: Feb. 25, 2010

(54) System and Method for Using Lifecycle Telecommunications Expense Management (TEM) Data to Predict the Outcome of Changes to Telecommunications Infrastructure

(76) Inventors: Kevin Dunetz, Fairfax Station, VA (US); Mike Gorman, Chapin, SC (US); Hector Nevarez, Ashburn, VA (US); John Shea, Vienna, VA (US); Kathy Smith, South Riding, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/392,972

(22) Filed: Feb. 25, 2009

Related U.S. Application Data
(60) Provisional application No. 61/031,179, filed on Feb. 25, 2008.

(51) Int. Cl. G06Q 10/00; G06Q 50/00

(52) U.S. Cl. 705/10; 705/7; 705/301

(57) ABSTRACT

In some embodiments, a method includes calculating costs associated with migration from a telecommunications infrastructure in a first configuration to the telecommunications infrastructure in a second configuration. The migration is based on a first infrastructure data and a second infrastructure data. The first infrastructure data is associated with the telecommunications infrastructure in the first configuration and the second infrastructure data is associated with the telecommunications infrastructure in the second configuration. A predictive migration model is generated based on the calculated costs, the first infrastructure data, and the second infrastructure data.

### RELATED APPLICATION

This application claims priority to U.S. Provisional Patent Application No. 61/031,179, entitled “System and Method for Using Lifecycle Telecommunications Expense Management (TEM) Data to Predict the Outcome of Changes to Telecommunications Infrastructure,” filed on Feb. 25, 2008, which is incorporated herein by reference in its entirety.

### BACKGROUND

This invention relates to telecommunication expense management, and, more particularly, to a telecommunication expense management system for predicting the outcome of changes to telecommunications infrastructure.

Businesses can often benefit from conducting a predictive analysis of their telecommunication infrastructure to ensure that the infrastructure investment is optimized and in line with the objectives of the business. Typically, the data collected and required for the analysis is missing, incomplete and/or stale. To correct this deficiency, additional data often needs to be collected, produced and verified, which can be expensive, time consuming and people intensive. Moreover, once there is sufficient data to conduct the analysis, the time to produce analysis results is in itself a slow process.

Thus, a need exists for a quicker and less expensive way for businesses to conduct predictive analysis on telecommunication infrastructure.

### SUMMARY OF THE INVENTION

In one embodiment, telecommunications expense management decision (TEMd) system, can be configured to generate a predictive telecommunications scenario assessment model based on future telecommunications infrastructure data, i.e., desired infrastructure data, and the existing telecommunications infrastructure data. The TEMd system uses a module that compares the content of both the desired infrastructure data and the current infrastructure data. An output of the comparison is generated and, in some embodiments, can be exported from the TEMd system for future use.

### BRIEF DESCRIPTION OF THE DRAWINGS

The invention is described with reference to the accompanying drawings. In the drawings, like reference numbers indicate identical or functionally similar components.

FIG. 1 is block diagram of a Telecommunications Expense Management decision (TEMd) system according to an embodiment.

FIG. 2 is a screenshot of an embodiment of a user-input module.

FIG. 3 is a screenshot of an embodiment of a user-input module.

FIG. 4 is a screenshot of an embodiment of a user-input module.

FIG. 5 is a screenshot of an embodiment of a user-input module.

FIG. 6 is a block diagram of a TEMd engine module according to an embodiment.

FIG. 7 is a screenshot of an embodiment of a predictive-analysis-output module.

FIG. 8 is a screenshot of an embodiment of a predictive-analysis-output module.

FIG. 9 is a block diagram of a TEMd system according to an embodiment.

FIG. 10 is a flow chart of a method according to an embodiment.

FIG. 11 is a flow chart of a method according to an embodiment.

FIG. 12 is a flow chart of a method according to an embodiment.

FIG. 13 is a block diagram of a TEMd engine module according to an embodiment.

### DETAILED DESCRIPTION

In some embodiments, a method includes calculating costs associated with migration from a telecommunications infrastructure in a first configuration to the telecommunications infrastructure in a second configuration. The migration is based on a first infrastructure data and a second infrastructure data. The first infrastructure data is associated with the telecommunications infrastructure in the first configuration and the second infrastructure data is associated with the telecommunications infrastructure in the second configuration. A predictive migration model is generated based on the calculated costs, the first infrastructure data, and the second infrastructure data. In some embodiments, the first infrastructure data is associated with a first carrier service provider and a first time, and the second infrastructure data is associated with a second carrier service provider and a second time later than the first time, as described herein.

In some embodiments, a method includes calculating upfront costs associated with migration from a telecommunications infrastructure in a first configuration to the telecommunications infrastructure in a second configuration. The calculating is based on at least one of a cost of circuit disconnect orders for the telecommunications infrastructure in the first configuration, a cost of circuit connection orders for the telecommunications infrastructure in the second configuration, early contractual termination fees for the telecommunications infrastructure in the first configuration, or a cost of new technology to support the telecommunications infrastructure in the second configuration. A return-on-investment timeframe associated with the migration is calculated. An amount of cost savings associated with the migration is calculated. An output is sent to an output module that is configured to display the output. The output is associated with a prediction of a business impact of the migration based on the upfront costs, the return-on-investment, and the amount of cost savings.

In other embodiments, a method includes generating a predictive model configured to predict a business impact of migration from a telecommunications infrastructure in a first configuration to the telecommunications infrastructure in a second configuration. The predictive model has calculated data that is based on a data associated with the telecommunications infrastructure in the first configuration and a data associated with the telecommunications infrastructure in the second configuration. The calculated data includes at least one of upfront costs associated with the migration, a return-on-investment associated with the migration, or an amount of cost savings associated with the migration. An output associated with the predictive model is sent to an output module that is configured to display the output. The output includes a representation of a prediction of the business impact based on the calculated data. In some embodiments, the output is displayed in at least one of a graphical format, a tabular format, or a spreadsheet format.

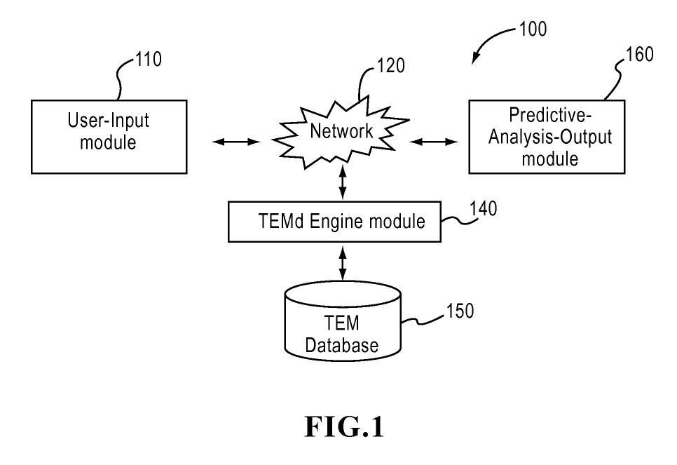

A telecommunications expense management decision (TEMd) system is described herein. Referring to FIG. 1, a TEMd system 100 includes a user-input module 110, a network 120 (e.g., the Internet), a TEMd engine module 140, a TEM database 150 and a predictive-analysis-output module 160. The user-input module 110 can be configured to communicate with the TEMd engine module 140 and the predictive-analysis-output module 160 through the network 120. Additionally, the predictive-analysis-output module 160 can be configured to communicate with the TEMd engine module 140 through the network 120. The TEMd engine module 140 can be configured to communicate with the TEM database 150. In some embodiments, the TEMd system 100 can be constructed based on manual, proprietary and/or commercial off-the-shelf components. In other embodiments, the TEMd system 100 can include automated (batch or transactional) data feeds. In yet other embodiments, the TEMd system 100 can include a security module to monitor access to the TEMd engine module 140.

In use, the user-input module 110 allows a user (e.g., a business analyst) to input desired telecommunications infrastructure information. The telecommunications infrastructure information relates to information about the telecommunications infrastructure, which can be characterized by, for example, the services, facilities and/or structures of a telecommunications network. The telecommunications network can be, for example, a wireless telecommunications network, a wired telecommunications network or a combination of both. Once the information is submitted by the user through the network 120, the submitted information is sent to the TEMd engine module 140. The TEMd engine module 140 compares the submitted information with the existing infrastructure data from the TEM database 150, as is described herein. The results of the comparison are generated and sent through the network 120 to the predictive-analysis-output module 160. In some embodiments, the network 120 can be the internet, intranet, a client server computing environment and/or the like.

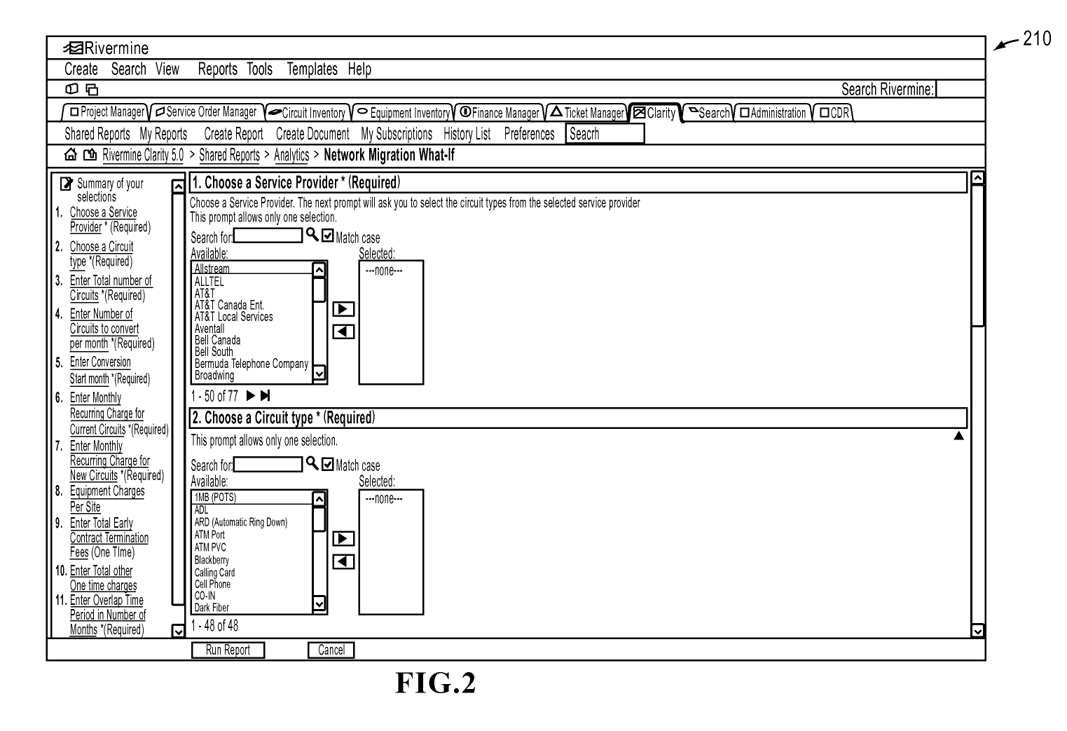

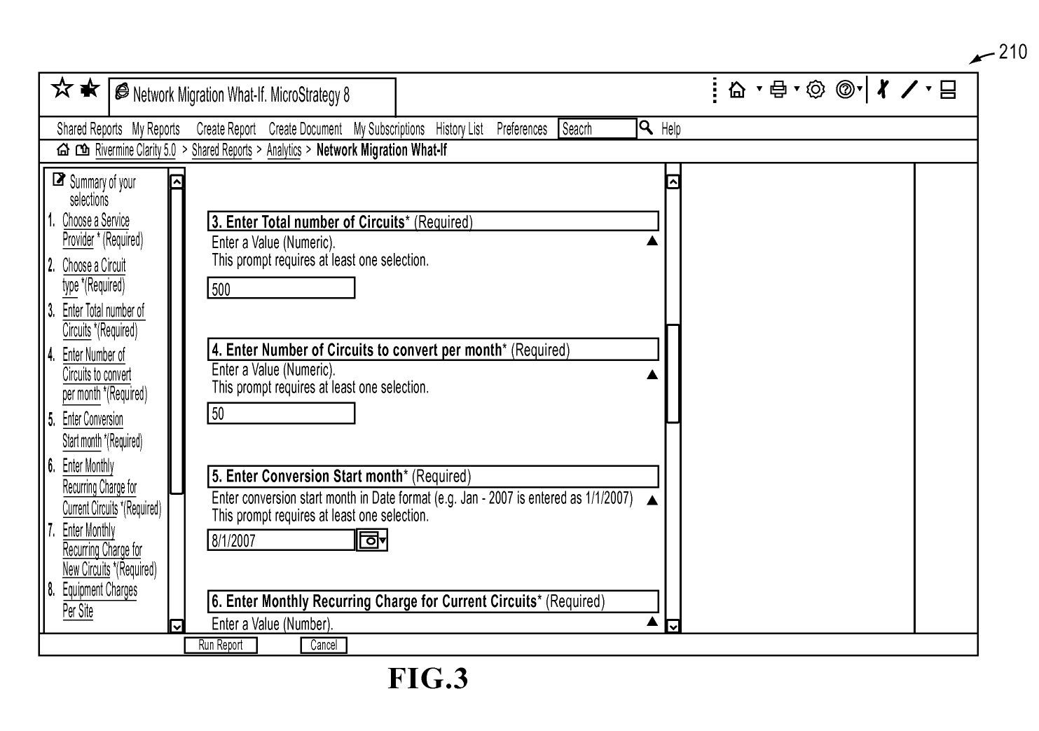

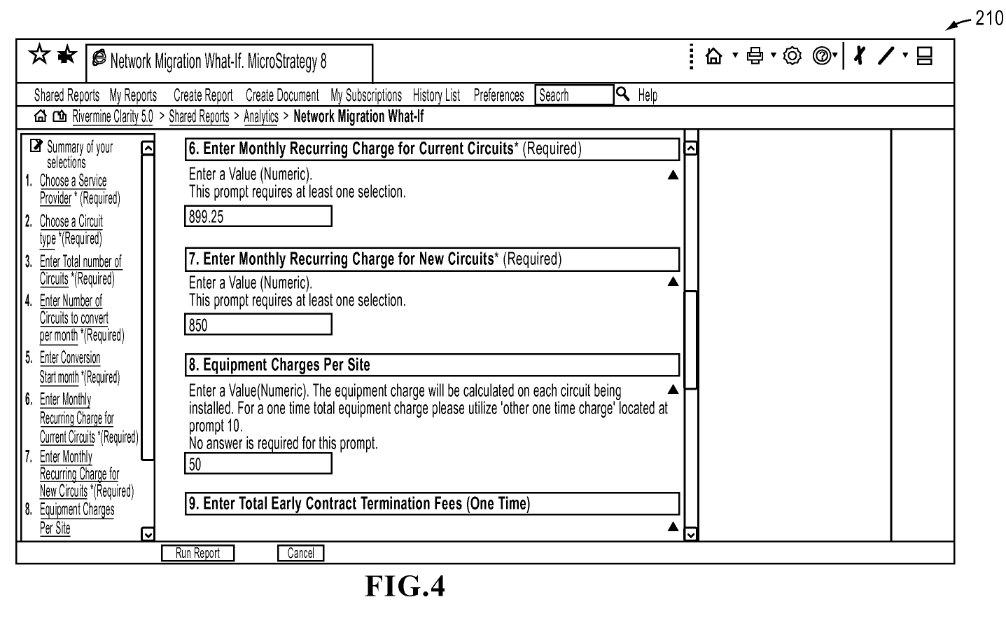

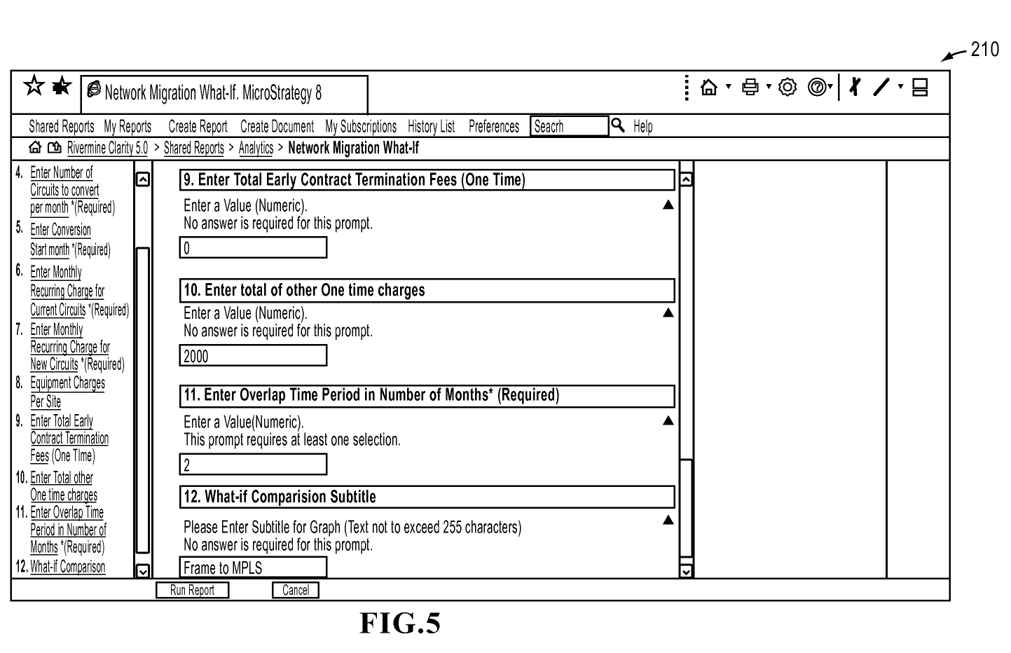

The user-input module 110 can be, for example, configured to be a web-based user interface. It can also be configured to take electronic feeds from other data sources including, but not limited to, industry benchmark/key performance indicator information. For example, in FIGS. 2-5, the output provided by a user-input module 210 can be windows based and can include pre-defined fields (e.g., drop-down menus and/or other usability features to facilitate data entry) containing telecommunications infrastructure criteria from which the user can choose to build the desired telecommunications infrastructure features or characteristics. Telecommunications infrastructure criteria information can include, but is not limited to, service providers, types of circuits, services and/or devices, the total number of circuits or devices to be converted, the number of circuits or devices to be converted per month, the conversion start date, costs for new circuits or devices and services, hardware and/or software upgrade costs, penalty fees of existing circuits or devices, preferred overlap time for the desired and existing infrastructure to be co-operational, industry benchmark data and/or the like. In some embodiments, the user-input module 210 can be a paper form, a spreadsheet or a computer-based form. In some embodiments, the user-input module 210 can be configured to communicate with an internet, intranet, a client-server computing environment and/or the like.

The TEM database 150 can be, for example, configured to contain the existing TEM infrastructure information and existing telecommunication carrier information (including information relative to all available carriers or information relative to those carriers available to the user). For example, the information in the TEM database 150 can include, but is not limited to, telecommunication information that spans the entire lifecycle of circuits, service plans, devices, etc. in areas such as sourcing, provisioning/order management, contracts, budgets, cost allocations, inventory, telecommunications spend, invoice details, disputes, tickets, carrier management and/or the like. More specifically, the information in the TEM database 150 can include, but it is not limited to:
national and international carrier information (including cable operators) for voice, data and wireless services;
sourcing information such as commercially available and private plans service rates;
budgetary information such as
   telecommunications budget plans,
   projected budget adjustments,
   budget variances, and
   budget trends;
cost allocations, such as
   direct cost allocations,
   indirect cost allocations,
   one time cost allocations, and
   percentage distribution cost allocations;
circuit entity to circuit entity dependencies, such as
   circuit-to-circuit,
   circuit-to-locations,
   circuit-to-people (wireless),
   circuit-to-equipment,
   circuit-to-contracts,
   circuit-to-vendors,
   circuit-to-invoices,
   circuit-to-invoice line items,
   circuits-to-invoice sub-line items (and related Uniform Service Order Codes (USOCs)),
   circuit-to-cost allocations,
   circuit-to-disputes,
   circuit-to-trouble tickets, and
   circuit-to-service orders;
contracts information, such as
   voice, data and wireless negotiated rates,
   contract start and end dates,
   earlier termination fees,
   contract terms and conditions,
   service level agreements (SLAs),
   dispute resolution terms,
   SLAs monetary resolution terms, and
   general vendor information;
inventory information, such as
   national and international telecom inventories,
   telecom inventory distributions (e.g., voice, data and/or wireless),
   carriers distribution (e.g., voice, data and/or wireless),
   equipment inventories
      hardware units,
      hardware to circuit relationships,
      hardware to hardware relationships,
      wireless PDA's,
      wireless cell phones,
      wireless air-cards,
      wireless pagers,
      wireless blackberries,
      location-to-location network routes mappings, and
      equipment-to-equipment network routes mappings;
telecom spend and invoice data, such as
   total telecom spending,
   spending distribution across voice, data and wireless services,
   spending distributions across carriers,
   detailed spending information, such as
      call detail records,
      detailed usage patterns,
      disputed amounts with carriers,
      optimization data between carrier plans, and
      USOC usage analysis,
   carrier invoice formats in use,
   carrier invoice media (e.g., electronic data interchange, web downloads, paper, CD and/or the like),
   carrier audit metrics (e.g., percentage of errors in invoices, percentage of error types distribution and the like), and
   carrier dispute metrics (e.g., average time to resolve disputes, average percent of cost savings per dispute totals and the like).

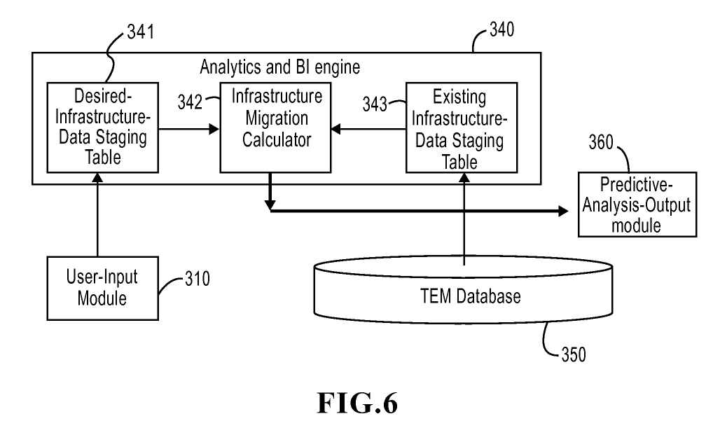

As previously described, the user-selected information from the user-input module 110 is submitted and is ultimately provided to the TEMd engine module 140. Referring to FIG. 6, the TEMd engine module 340 (also referred to as “Analytics and Business Intelligence (BI) engine”) includes a desired-infrastructure-data staging table 341, an infrastructure migration calculator 342 and an existing-infrastructure-data staging table 343. The desired-infrastructure-data staging table 341 can be configured to temporarily store submitted information from a user-input module 310. The existing-infrastructure-data staging table 343 can be configured to temporarily store existing infrastructure data from a TEM database 350. The infrastructure migration calculator 342 is configured to access and use the information stored in the desired-infrastructure-data staging table 341 and the existing-infrastructure-data staging table 343 to generate an infrastructure-migration predictive model to send to a predictive-analysis output module 360.

Unlike the information contained in the desired-infrastructure-data staging table 341, which is defined by the user via the user-input module 310, as previously discussed, the information contained in the existing-infrastructure-data staging table 343 can be automatically generated based on data from the TEM database 350. Said another way, the information contained in the existing-infrastructure-data staging table 343 can be obtained from the TEM database 350 and modified without user intervention. The information obtained from the TEM database 350 can be the most up-to-date TEM data at the time the information is obtained. This increases the freshness of the TEM data.

As discussed above, in some embodiments, the infrastructure migration calculator 342 can be configured to compare the information stored in the desired-infrastructure-data staging table 341 and the existing-infrastructure-data staging table 343 to generate an output. For example, when the information is obtained from the desired-infrastructure-data staging table 341 and the existing-infrastructure-data staging table 343, the infrastructure migration calculator 342 can be configured to compare the infrastructure data from the desired-infrastructure-data staging table 341 with the infrastructure data from the existing-infrastructure-data staging table 343.

In some embodiments, the infrastructure migration calculator 342 uses mathematical and/or statistical algorithms to compare the data and generate infrastructure-migration predictive models. For example, the infrastructure migration calculator 342 can be configured to use a comparison algorithm to provide carrier provider pricing analysis. More specifically, the algorithm can compare between the current carrier provider pricing and the desired carrier provider pricing selected by the user. As previously discussed, the current carrier provider pricing is provided by the existing-infrastructure-data staging table 343 and the desired carrier provider is provided by the desired-infrastructure-data staging table 341. The pricing information for the desired carrier provider, however, is stored in the TEM database 350, and as a result, the existing-infrastructure-data staging table 343 is the source of the desired carrier provider pricing provided to the infrastructure migration calculator 342. Therefore, the infrastructure migration calculator 342 has the added task of matching up the desired carrier provider selected by the user from the desired-infrastructure-data staging table 341 with the corresponding pricing information provided by the existing-infrastructure-data staging table 343. Using the provided information, the infrastructure migration calculator 342 can determine an improved or most cost-efficient carrier provider for the business and can generate a corresponding infrastructure-migration predictive model.

Similarly, in some embodiments, the infrastructure migration calculator 342 can be configured to use a comparison algorithm to provide cost analysis. For example, the infrastructure migration calculator 342 can compare the cost of circuit disconnect orders for the existing infrastructure with the cost of new circuit connection orders for the desired infrastructure, the early contractual termination fees for the existing infrastructure with the new equipment/technology costs to support the desired infrastructure and/or the like.

In some embodiments, the infrastructure migration calculator 342 can be based on a series of mathematical algorithms performed manually or automatically using an intranet, internet, a client server computing environment and/or the like.

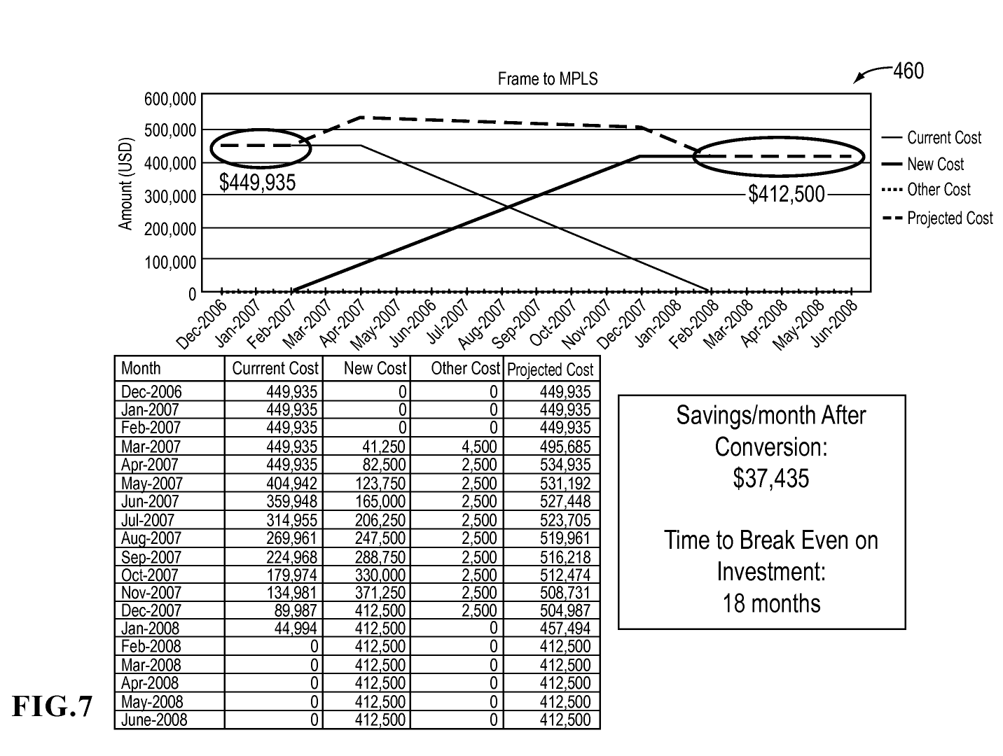

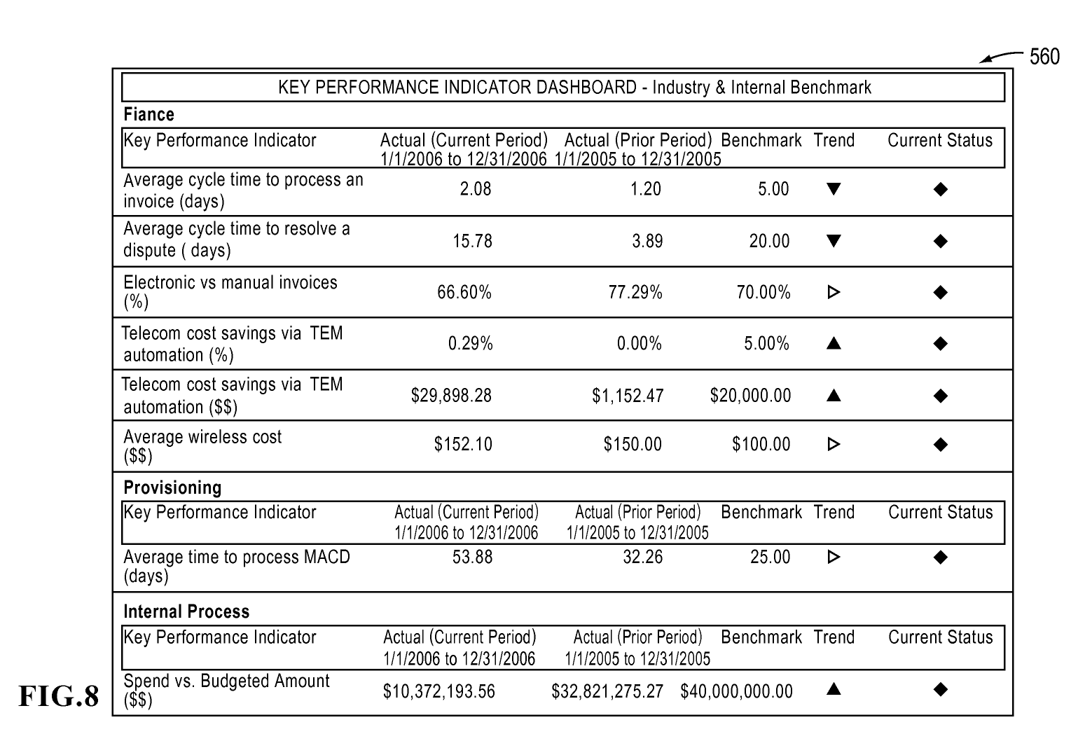

Once the infrastructure migration calculator 342 generates the infrastructure-migration predictive model, the infrastructure-migration predictive model is sent to a predictive-analysis output module 360 for output to the user. The predictive-analysis output module 360 can be configured to display the model results at a user interface. For example, as shown in FIGS. 7 and 8, output 460 and 560 from predictive analysis output module 360 can be configured to display results in a graphical, tabular and/or spreadsheet format. Additionally, in some embodiments, the results can be exported out of the TEMd system 100.

Although the output 560 in FIG. 8 is described above in connection with the infrastructure-migration predictive model, it should be understood that the information shown in output 560 can be determined and/or displayed independent of the infrastructure-migration predictive model and without performing the calculations associated with a potential migration. For example, although in some embodiments the output 560 is based on infrastructure data from the TEM database (e.g., TEM database 350) and infrastructure data from the user-input module (e.g., user-input module 310), it should be understood that the output 560 can be based on infrastructure data from the TEM database without being based on user input. In other words, the output 560 does not need to be associated with the infrastructure-migration predictive model. For example, in some embodiments, the output 560 can be an output from a key performance model (as shown in FIG. 8). The key performance model can be configured to calculate a trend analysis based on a comparison of internal benchmark ratings associated with key performance indicators and industry benchmark ratings associated with those key performance indicators. Such key performance indicators can be, for example, an average cycle time to process an invoice (measured in days), and an average cycle time to resolve a dispute (measure in days). Additionally, the key performance indicators can be in the business areas of finance, provisioning and/or internal process. The internal benchmark ratings can be based on, for example, the current infrastructure data (i.e., actual infrastructure data). The internal benchmark ratings and/or the industry benchmark ratings can be obtained, for example, from the TEM database. In some embodiments, the infrastructure migration calculator 342 can be configured to calculate the trend analysis and/or generate the key performance model.

In some embodiments, any other suitable module (not shown) can be configured to calculate the trend analysis and/or generate the key performance model. The output 560 from such a key performance model can be configured to visually display the trend analysis in, for example, the predictive analysis output module 360. In some embodiments, however, the output 560 can be visually displayed in any other suitable module (not shown). As shown in FIG. 8, the output 560 includes a listing of performance indicators (shown as “key performance indicators”), an internal benchmark rating associated with each performance indicator over a current time period, an internal benchmark rating associated with each performance indicator over a prior time period, an industry benchmark rating associated with each performance indicator, and a trend indicator associated with each performance indicator. The trend indicator visually indicates whether the internal benchmark ratings associated with the current time period and the prior time period are below (downward arrow) or above (upward arrow) the industry benchmark of that particular performance indicator. In some embodiments, the performance indicators and/or the duration of time associated with the current time period and the prior time period can be selected by a user using the user-input module 310.

Although the output 560 is shown in a particular format, it should be understood that other formats and data formats are possible. For example, rather than displaying the performance indicator values along side the industry benchmark rating, instead a variation indicator can be displayed, such a percentage variance, color-based indicators, etc.

Information contained in the infrastructure-migration predictive models can include, but is not limited to, migration upfront costs, the return on investment timeframe, concurrent spending required to support the overall conversion project, after conversion cost savings, performance against industry benchmarks/key performance indicators, network routing diagrams and the costs associated with different potential network routes, network routes utilization and capacity plans, and/or other influential key predictive components.

In some embodiments, the infrastructure-migration predictive models can be generated by the infrastructure migration calculator 342 “on demand” when the user submits desired infrastructure information via the user-input module 310. In other embodiments, the infrastructure-migration predictive models can be automatically generated according to a pre-determined schedule. For example, the infrastructure-migration predictive models can be scheduled to automatically generate once a week, once a month, once a quarter and/or the like. In some embodiments, the generated infrastructure-migration predictive models can be automatically emailed to a user or a set of multiple users.

In some embodiments, the predictive-analysis output module can be a manually generated paper based form using an intranet, internet, a client server computing environment and/or the like.

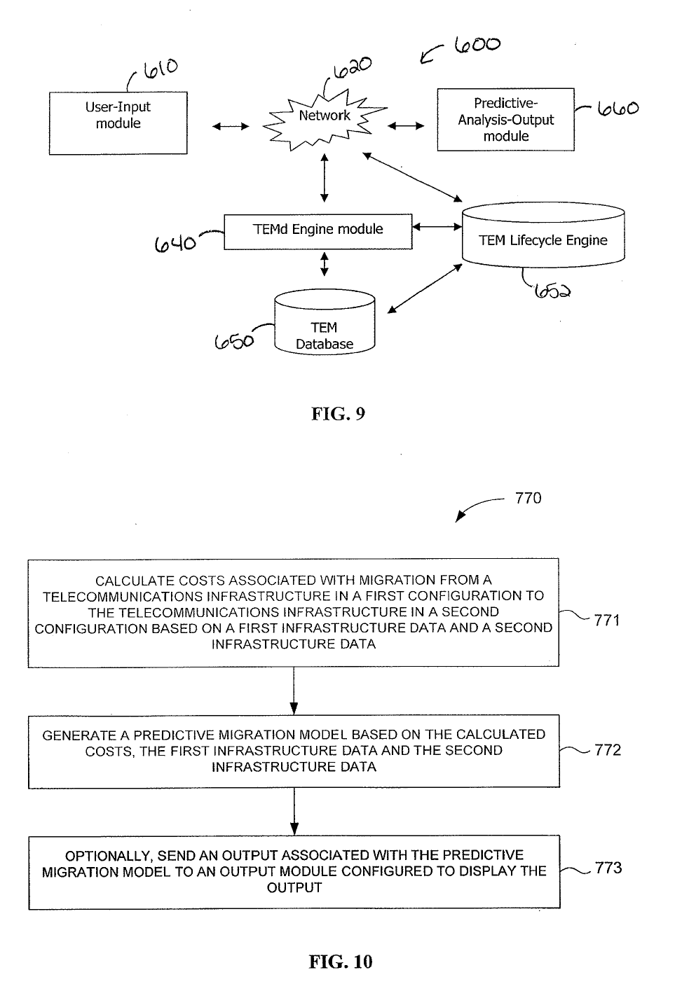

Although the TEMd system 100 is shown and described herein as having a TEM database 150 that stores and collects infrastructure data, the TEMd system of other embodiments can include a TEMd lifecycle engine. For example, in FIG. 9, a TEMd system 600 includes a user-input module 610, a network (e.g., the Internet) 620, a TEMd engine module 640, a TEM database 650, a TEM lifecycle engine 652 and a predictive-analysis output module 660. Similar to the previous embodiments, the user-input module 610 can be configured to communicate with the TEMd engine module 640 and the predictive-analysis-output module 660 through the network 620. The predictive-analysis-output module 660 can be configured to communicate with the TEMd engine module 640 through the network 620. The TEMd engine module 640 can be configured to communicate with the TEM database 650. Additionally, the TEM lifecycle engine 652 can be configured to communicate with the TEM database 650.

The TEM lifecycle engine 652 is configured to connect to the network 620 and to search for the most up-to-date information regarding telecommunications infrastructure. For example, the TEM lifecycle engine 652 can search on the internet for the most recent telecommunications carrier product pricing and download that information for future use. All of the updated telecommunications infrastructure information retrieved by the TEM lifecycle engine 652 is provided to and stored in the TEM database 650 for later or concurrent use in generating infrastructure-migration predictive models.

As previously discussed, the TEM database 650 can be configured to store telecommunications catalogs information and other comprehensive data provided by the TEM lifecycle engine 652. For example, the TEM database 650 can store the catalog price associated with a T-1 line from AT&T and, similarly, the catalog price for a T-1 line from Verizon. In addition, the TEM database 650 can be configured to store other types of TEM lifecycle data, for example, associated with provisioning, inventory, and financial management for AT&T and Verizon services, as described herein. TEM lifecycle data 652 further can include, for example, average service disconnect times, average service connect times, one time charges, monthly reoccurring charges, contractual rates and fees, and/or the like. The information stored in the TEM database 650 can be provided to the infrastructure migration calculator (not shown) which makes use of this information when generating an infrastructure-migration predictive model to predict the business impact of migrating T-1 service from AT&T to Verizon.

As discussed above, the infrastructure migration calculator can be configured to generate specific infrastructure-migration predictive models for technology telecommunications infrastructure changes. These can include, but are not limited to Frame Relay to VoIP/MPLS and equipment technology (100M to 1G Ethernet) network conversions, carrier rate negotiations, carrier changes, optimization of wireless service plans and devices, and/or the like.

The TEM lifecycle engine 652 can be configured to include, for example, an inventory manager (not shown), an order and provisioning manager (not shown) and/or a finance manager (not shown). The inventory manager is configured to build and maintain a database containing the most up-to-date information regarding all wired, wireless, and data networking assets. In some embodiments, the inventory manager is configured to automatically update every time an order is processed with a service provider. Additionally, the order manager and the provisioning manager can be configured to create, validate and track all telecommunication orders from requests through approval and provisioning by a service provider. Finally, the finance manager can be configured to enable automated invoice processing, bill validation, cost allocation, auditing, dispute processing and/or the like. In some embodiments, the finance manager can be configured to check all invoices from a service provider against the inventory data provided the inventory manager to ensure that the business only pays for the telecommunications infrastructure it is using.

Although the infrastructure migration calculator is described herein as generating a predictive telecommunications scenario assessment models using the user selected information, the infrastructure migration calculator can be configured to generate an assessment model based on values in close proximity to the user selected information. For example, when a user chooses to generate an assessment model to determine the cost-effectiveness of converting fifty circuits per month to a new infrastructure carrier, the infrastructure migration calculator can be configured to also generate an additional assessment model on the cost-effectiveness of converting fifty-five circuits per month and forty-five circuits per month. This can allow a user to consider minor variations to the user selection, and then consider the cost impact of these minor variations.

Although the TEMd engine module is shown and described herein as having a existing-infrastructure-data staging table and a desired-infrastructure-data staging table, the TEMd engine module can include a flat file, a spreadsheet, a database, an XML feed and/or the like, either alone or in combination with an existing-infrastructure-data staging table and/or a desired-infrastructure-data staging table. Additionally, in some embodiments, the TEMd engine module can include any type of sub-module that can be configured to temporarily store infrastructure data. In some embodiments, the TEMd engine module can extract data directly and in real-time from the user-input module, the TEM database and/or the TEM lifecycle engine without creating a set of staging tables. Similarly, in some embodiments, the TEMd engine module can export data directly to the predictive-analysis-output module without the use of staging tables.

Although the desired-infrastructure-data staging table is described herein as being configured to temporarily store user-submitted information for a single assessment, the desired-infrastructure-data staging table can be configured to save user-submitted information for subsequent assessments. Additionally, the desired-infrastructure-data staging table can be configured to save the user submitted information from multiple assessments.

Although the TEMd system is described herein as being used by a single business to generate predictive telecommunications scenario assessment models, the TEMd system can be used by multiple companies to generate predictive telecommunications scenario assessment models. For example, the TEMd system can be operated by a consulting firm providing telecommunication solutions to multiple companies. Therefore, in some embodiments, the TEMd system can have password protection to access information corresponding to a particular business.

Although the TEMd system is shown and described herein as having a single TEM database, the TEMd system can include a plurality of databases. For example, the TEMd system can have a database for the existing TEM infrastructure data and a separate database for the existing telecommunication carrier information. In some embodiments, the existing telecommunication carrier information database can be configured to communicate directly with the desired-infrastructure-data staging table.

FIG. 10 is a flow chart of a method 770 according to an embodiment. The method 770 includes calculating costs associated with migration from a telecommunications infrastructure in a first configuration to the telecommunications infrastructure in a second configuration based on a first infrastructure data and a second infrastructure data, 771. The first infrastructure data is associated with the telecommunications infrastructure in the first configuration and the second infrastructure data is associated with the telecommunications infrastructure in the second configuration. The telecommunications infrastructure can be, for example, a wired telecommunications infrastructure and/or a wireless telecommunications infrastructure. In some embodiments, the second infrastructure data is associated with user-selected telecommunications infrastructure criteria. Such telecommunications infrastructure criteria can include, for example, at least one of a service provider identifier, a service identifier, a wireless device identifier, a total number of circuits to be converted, a total number of circuits to be converted per month, total number of wireless users to be converted per month, a conversion start date, or an industry benchmark. In some such embodiments, the telecommunications infrastructure criteria can be selected by a user via a user-input module (e.g., user-input modules 110, 310, and 610 shown in FIGS. 1, 6 and 9, respectively).

In some embodiments, the first infrastructure data can include pricing associated with a first carrier service provider and a first time, and the second infrastructure data can include pricing associated with a second carrier service provider and a second time later than the first time. For example, in some embodiments, the first carrier service provider can be a current carrier service provider such that the first time is the present time. Additionally, the second carrier service provider can be a desired carrier service provider such that the second time is a future time. In this manner, the costs associated with the migration can be calculated based on pricing associated with the current carrier service provider at the present time and the pricing associated with the potential desired carrier service provider at a future time.

Similarly, in some embodiments, the telecommunications infrastructure in the first configuration can be associated with a telecommunications infrastructure at a first time and the telecommunications infrastructure in the second configuration can be associated with a telecommunications infrastructure at a second time later than the first time. For example, in some embodiments, the telecommunications infrastructure in the first configuration can be associated with a current telecommunications infrastructure and the telecommunications infrastructure in the second configuration can be associated with a desired telecommunications infrastructure, as described above.

In some embodiments, the calculating is based on a comparison of at least one of a cost of circuit disconnect orders for the telecommunications infrastructure in the first configuration with a cost of circuit connection orders for the telecommunications infrastructure in the second configuration, or early contractual termination fees for the telecommunications infrastructure in the first configuration with costs of new technology to support the telecommunications infrastructure in the second configuration, as described above.

The method includes generating a predictive migration model based on the calculated costs, the first infrastructure data and the second infrastructure data, 772. In some embodiments, the predictive migration model can include at least one of a cost analysis, a performance-against-industry benchmark analysis, or a data representation of a physical network diagram of the telecommunications infrastructure in the second configuration, as described above. In some such embodiments, the predictive migration model can be configured to predict a business impact of the migration.

In some embodiments, the telecommunications infrastructure can have multiple alternative second configurations such that the predictive migration model is generated based on, at least in part, a second infrastructure data associated with the telecommunications infrastructure in an optimal second configuration. For example, the telecommunications infrastructure in the optimal second configuration can be the configuration that has the least costs associated with migration from the telecommunications infrastructure in the first configuration to the telecommunications infrastructure in that second configuration. In some such embodiments, the calculating includes calculating costs associated with each migration from the telecommunications infrastructure in the first configuration to the telecommunications infrastructure in each alternative second configuration. In some such embodiments, the calculated costs associated with each migration is compared to determine the optimal second configuration (i.e., the optimal migration from the telecommunications infrastructure in the first configuration to the telecommunications infrastructure in the optimal second configuration). In this manner, the predictive migration model is generated based on the calculated costs associated with the optimal migration, the first infrastructure data and the second infrastructure data associated with the telecommunications infrastructure in the optimal second configuration.

In some embodiments, the method can optionally further include sending an output associated with the predictive migration model to an output module configured to display the output, 773. The output can be displayed, for example, in at least one of a graphical format, a tabular format, or a spreadsheet format.

FIG. 11 is a flow chart of a method 880 according to an embodiment. The method includes calculating upfront costs associated with migration from a telecommunications infrastructure in a first configuration to the telecommunications infrastructure in a second configuration, 881. The calculating is based on at least one of a cost of circuit disconnect orders for the telecommunications infrastructure in the first configuration, a cost of circuit connection orders for the telecommunications infrastructure in the second configuration, early contractual termination fees for the telecommunications infrastructure in the first configuration, or a cost of new technology to support the telecommunications infrastructure in the second configuration. In some embodiments, the calculating upfront costs is based on a comparison of at least one of the costs of circuit disconnect orders with the cost of circuit connection orders, or the early contractual termination fees with the cost of new technology. The telecommunications infrastructure can be, for example, a wired telecommunications infrastructure and/or a wireless telecommunications infrastructure.

In some embodiments, the telecommunications infrastructure in the second configuration is defined, at least in part, by user-selected telecommunications infrastructure criteria. Such telecommunications infrastructure criteria can include, for example, at least one of a service provider identifier, a service identifier, a wireless device identifier, a total number of circuits to be converted, a total number of circuits to be converted per month, total number of wireless users to be converted, a conversion start date, or an industry benchmark. In some such embodiments, the telecommunications infrastructure criteria can be selected by a user via a user-input module (e.g., user-input modules 110, 310, and 610 shown in FIGS. 1, 6 and 9, respectively).

In some embodiments, the telecommunications infrastructure in the first configuration can be associated with a telecommunications infrastructure at a first time and the telecommunications infrastructure in the second configuration can be associated with a telecommunications infrastructure at a second time later than the first time. For example, in some embodiments, the telecommunications infrastructure in the first configuration can be associated with a current telecommunications infrastructure and the telecommunications infrastructure in the second configuration can be associated with a desired telecommunications infrastructure, as described above.

The method includes calculating a return-on-investment timeframe associated with the migration, 882. In some embodiments, the calculating the return-on-investment timeframe is based on an amount of cost savings and the upfront costs. For example, in some embodiments, the calculating can include comparing the amount of cost savings over a time period with the upfront costs.

The method includes calculating an amount of cost savings associated with the migration, 883. In some embodiments, the calculating the amount of cost savings can include subtracting a cost of the telecommunications infrastructure in the second configuration over a time period from a cost of the telecommunications infrastructure in the first configuration over the time period. For example, in the context of a carrier service provider, the telecommunications infrastructure in the first configuration can be associated with pricing related to a first carrier service provider over a time period and the telecommunications infrastructure in the second configuration can be associated with a pricing related to a second carrier service provider over the time period. In this manner, the pricing of the second carrier service provider can be subtracted from the pricing of the first carrier service provider to calculate an amount of cost savings associated with migrating from the first carrier provider to the second carrier provider. The time period can be any duration of time, such as, for example, a day, a week, a month, a year and/or the like.

The method includes sending an output to an output module configured to display the output, 884. The output is associated with a prediction of a business impact of the migration based on the upfront costs, the return-on-investment, and the amount of cost savings. In some embodiments, the output module can be a predictive-analysis-output module (e.g., predictive-analysis-output modules 160, 360, and 660 shown in FIGS. 1, 6 and 9, respectively).

In some embodiments, the telecommunications infrastructure can be analyzed with multiple alternative second configurations such that the prediction of the business impact of the migration is based on upfront costs, a return-on-investment timeframe, and/or an amount of cost savings associated with a migration from the telecommunications infrastructure in the first configuration to the telecommunications infrastructure in a particular second configuration (e.g., an optimal second configuration). For example, the telecommunications infrastructure in the particular second configuration can be the configuration that has the least upfront costs, the least return-on-investment timeframe, and/or the most amount of cost savings associated with the migration from the telecommunications infrastructure in the first configuration to the telecommunications infrastructure in that second configuration. In some such embodiments, upfront costs, a return-on-investment timeframe, and/or an amount of cost savings associated with each migration from the telecommunications infrastructure in the first configuration to the telecommunications infrastructure in each alternative second configuration can be calculated. In some such embodiments, the upfront costs, the return-on-investment timeframe, and/or the amount of cost savings from each migration can be compared to determine an optimal second configuration (e.g., the optimal migration from the telecommunications infrastructure in the first configuration to the telecommunications infrastructure in an optimal second configuration). In this manner, the prediction of the business impact of the migration is based on the upfront costs associated with the optimal migration, the return-on-investment associated with the optimal migration, and/or the amount of cost savings associated with the optimal migration. It should be understood that an optimal migration may be based on certain criteria and an optimal migration may differ based on a different criteria. For example, in some embodiments, the user can select a particular criteria from which the optimal (or preferred, desired) migration can be determined.

In some embodiments, the calculating upfront costs, the calculating the return-on-investment timeframe, the calculating the amount of cost savings, and the sending are performed by a business intelligence engine, as described above. In some embodiments, the business intelligence engine can include a telecommunications infrastructure migration calculator (e.g., the infrastructure migration calculator 342 shown in FIG. 6) that is configured to perform the calculating upfront costs, the calculating the return-on-investment timeframe, the calculating the amount of cost savings, and the sending.

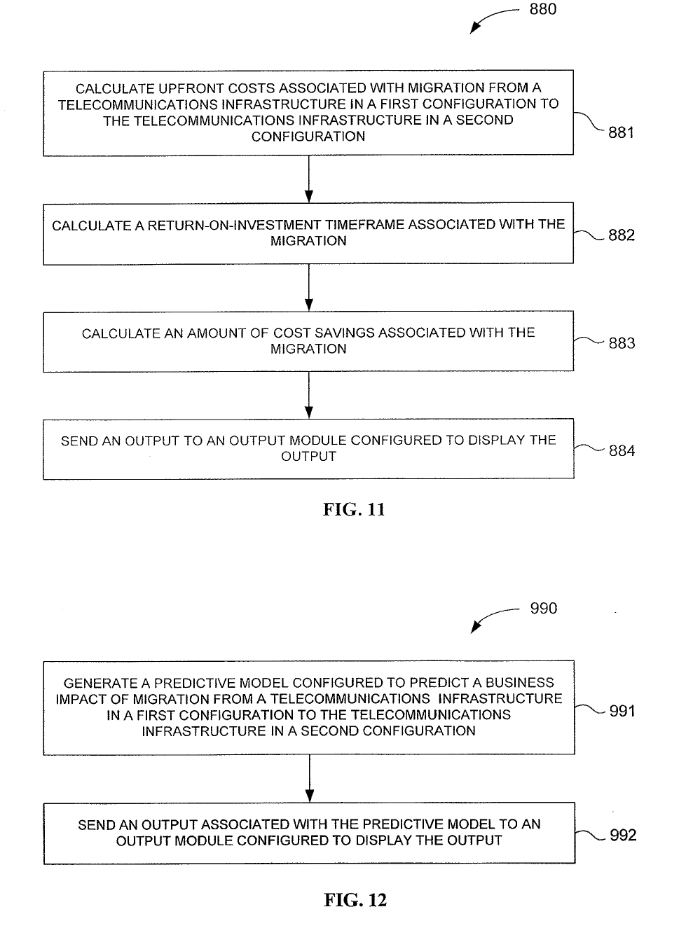

FIG. 12 is a flow chart of a method 990 according to an embodiment. The method includes generating a predictive model configured to predict a business impact of migration from a telecommunications infrastructure in a first configuration to the telecommunications infrastructure in a second configuration, 991. The predictive model has calculated data that is based on a data associated with the telecommunications infrastructure in the first configuration and a data associated with the telecommunications infrastructure in the second configuration. The calculated data includes at least one of upfront costs associated with the migration, a return-on-investment associated with the migration, or an amount of cost savings associated with the migration. In some embodiments, the calculated data includes at least one of a cost analysis, a performance-against-industry benchmark analysis, or a data representation of a physical network diagram of the telecommunications infrastructure in the second configuration, as described above. The telecommunications infrastructure can be, for example, a wired telecommunications infrastructure and/or a wireless telecommunications infrastructure.

In some embodiments, the data associated with the telecommunications infrastructure in the second configuration is associated with user-selected telecommunications infrastructure criteria. Such telecommunications infrastructure criteria can include, for example, at least one of a service provider identifier, a service identifier, a wireless device identifier, a total number of circuits to be converted, a total number of circuits to be converted per month, total number of wireless users to be converted, a conversion start date, or an industry benchmark. In some such embodiments, the user-selected telecommunications infrastructure criteria are representative of a desired telecommunications infrastructure.

In some embodiments, the telecommunications infrastructure in the first configuration can be associated with a telecommunications infrastructure at a first time and the telecommunications infrastructure in the second configuration can be associated with a telecommunications infrastructure at a second time later than the first time. For example, in some embodiments, the telecommunications infrastructure in the first configuration can be associated with a current telecommunications infrastructure and the telecommunications infrastructure in the second configuration can be associated with a desired telecommunications infrastructure, as described above.

The method includes sending an output associated with the predictive model to an output module configured to display the output, 992. The output includes a representation of a prediction of the business impact based on the calculated data. In some embodiments, the output is displayed in at least one of a graphical format, a tabular format, or a spreadsheet format. In some embodiments, the output module can be a predictive-analysis-output module (e.g., predictive-analysis-output modules 160, 360, and 660 shown in FIGS. 1, 6 and 9, respectively).

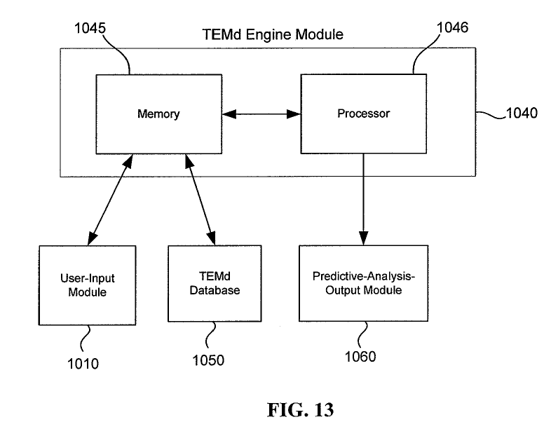

FIG. 13 is a block diagram of a TEMd engine module 1040 according to an embodiment. The TEMd engine module 1040 includes a memory 1045 and a processor 1046. The memory 1045 is configured to store submitted information from a user-input module 1010. Additionally, the memory 1045 is configured to store existing infrastructure information from a TEMd database 1050. The processor 1046 is configured to access and use the information stored in the memory 1045 to generate a telecommunications infrastructure-migration predictive model to send to a predictive-analysis-output module 1060. In some embodiments, the memory 1045 can be configured to store information temporarily. In some embodiments, the memory 1045 can be configured to store information permanently. In other embodiments, the TEMd database 1050 can be stored in the memory 1045.

In some embodiments, one or more portions of the TEMd engine module 1040, the user-input module 1010, the TEMd database 1050 and/or the predictive-analysis-output module 1060 can be a hardware-based module (e.g., a digital signal processor (DSP), a field programmable gate array (FPGA), a memory), a firmware-based module, and/or a software-based module (e.g., a module of computer code, a set of computer-readable instructions that can be executed at a computer). In some embodiments, one or more of the functions associated with the TEMd engine module 1040, the user-input module 1010, the TEMd database 1050 and/or the predictive-analysis-output module 1060 can be included in one or more different modules (not shown). In some embodiments, one or more portions of the TEMd engine module 1040, the user-input module 1010, the TEMd database 1050 and/or the predictive-analysis-output module 1060 can be a wired device and/or a wireless device (e.g., wi-fi enabled device) and can be, for example, a computing entity (e.g., a personal computing device), a mobile phone, a personal digital assistant (PDA), a server (e.g., a web server/host), and/or so forth. The TEMd engine module 1040, the user-input module 1010, the TEMd database 1050 and/or the predictive-analysis-output module 1060 can be configured to operate based on one or more platforms (e.g., one or more similar or different platforms) that can include one or more types of hardware, software, firmware, operating systems, runtime libraries, and so forth.

In some embodiments, the TEMd engine module 1040 (or portion of the TEMd engine module 1040), the user-input module 1010 (or portion of the user-input module 1010), the TEMd database 1050 (or portion of the TEMd database 1050) and/or the predictive-analysis-output module 1060 (or portion of the predictive-analysis-output module 1060) can be configured to communicate via a network (not shown). In some embodiments, the network can be, for example, a virtual network, a local area network (LAN) and/or a wide area network (WAN) and can include one or more wired and/or wireless segments. For example, the TEMd database 1050 can be accessed (e.g., manipulated) as a web-based service. Accordingly, the user-input module 1010 can be, for example, a personal computer, and the TEMd engine module 1040 can be accessed via, for example, the Internet. In some embodiments, the TEMd engine module 1040 can be configured to facilitate communication (e.g., collaboration) between users (e.g., users at separate, remote locations).

Although the TEMd engine module 1040 is illustrated and described above as having the processor 1046 and the memory 1045, it should be understood that other modules can have a processor and/or memory. Such other modules can include, for example, the user-input module 1010, the TEMd database 1050, and the predictive-analysis-output module 1060.

In some embodiments, the TEMd engine module, the user-input module, the TEMd database and/or the predictive-analysis-output module can include a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, AJAX, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, and not limitation. While specific embodiments have been described, it will be understood that various changes in form and details may be made. Where methods described above indicate certain events occurring in certain order, the ordering of certain events may be modified. Additionally, certain of the events may be performed concurrently in a parallel process when possible, as well as performed sequentially as described above.

Although various embodiments have been described as having particular features and/or combinations of components, other embodiments are possible having a combination of any features and/or components from any of embodiments where appropriate. For example, in some embodiments, the TEM database can be a collection of spreadsheets, word documents and/or the like. In some embodiments, the TEM database can be configured to communicate with an intranet, a client server computing environment and/or the like.

Although the TEM lifecycle engine 652 is described as retrieving telecommunication information electronically, the TEM lifecycle engine 652 can be configured to update telecommunication information in paper form.

What is claimed is:

1. A method, comprising:
calculating costs associated with migration from a telecommunications infrastructure in a first configuration to the telecommunications infrastructure in a second configuration based on a first infrastructure data and a second infrastructure data, the first infrastructure data associated with the telecommunications infrastructure in the first configuration, the second infrastructure data associated with the telecommunications infrastructure in the second configuration; and
generating a predictive migration model based on the calculated costs, the first infrastructure data and the second infrastructure data.

2. The method of claim 1, further comprising:
sending an output associated with the predictive migration model to an output module configured to display the output, the output being displayed in at least one of a graphical format, a tabular format, or a spreadsheet format.

3. The method of claim 1, wherein the telecommunications infrastructure in the first configuration is associated with a telecommunications infrastructure at a first time and the telecommunications infrastructure in the second configuration is associated with a telecommunications infrastructure at a second time later than the first time.

4. The method of claim 1, wherein the predictive migration model includes at least one of a cost analysis, a performance-against-industry benchmark analysis, or a data representation of a physical network diagram of the telecommunications infrastructure in the second configuration.

5. The method of claim 1, wherein the second infrastructure data is associated with user-selected telecommunications infrastructure criteria including at least one of a service provider identifier, a service identifier, a wireless device identifier, a total number of circuits to be converted, a total number of circuits to be converted per month, a total number of wireless users to be converted, a conversion start date, or an industry benchmark.

6. The method of claim 1, wherein the first infrastructure data includes pricing associated with a first carrier service provider and a first time, and a second infrastructure data includes pricing associated with a second carrier service provider and a second time later than the first time.

7. The method of claim 1, wherein the calculating includes calculating based on a comparison of at least one of a cost of circuit disconnect orders for the telecommunications infrastructure in the first configuration with a cost of circuit connection orders for the telecommunications infrastructure in the second configuration, or early contractual termination fees for the telecommunications infrastructure in the first configuration with costs of new technology to support the telecommunications infrastructure in the second configuration.

8. A method, comprising:
calculating upfront costs associated with migration from a telecommunications infrastructure in a first configuration to the telecommunications infrastructure in a second configuration, the calculating being based on at least one of a cost of circuit disconnect orders for the telecommunications infrastructure in the first configuration, a cost of circuit connection orders for the telecommunications infrastructure in the second configuration, early contractual termination fees for the telecommunications infrastructure in the first configuration, or a cost of new technology to support the telecommunications infrastructure in the second configuration;
calculating a return-on-investment timeframe associated with the migration;
calculating an amount of cost savings associated with the migration; and
sending an output to an output module configured to display the output, the output being associated with a prediction of a business impact of the migration based on the upfront costs, the return-on-investment, and the amount of cost savings.

9. The method of claim 8, wherein the calculating upfront costs, the calculating the return-on-investment timeframe, the calculating the amount of cost savings, and the sending are performed by a business intelligence engine.

10. The method of claim 8, wherein the telecommunications infrastructure in the first configuration is associated with a telecommunications infrastructure at a first time and the telecommunications infrastructure in the second configuration is associated with a telecommunications infrastructure at a second time later than the first time.

11. The method of claim 8, wherein the telecommunications infrastructure in the second configuration is defined, at least in part, by user-selected telecommunications infrastructure criteria including at least one of a service provider identifier, a service identifier, a wireless device identifier, a total number of circuits to be converted, a total number of circuits to be converted per month, a total number of wireless users to be converted, a conversion start date, or an industry benchmark.

12. The method of claim 8, wherein the calculating upfront costs is based on a comparison of at least one of the cost of circuit disconnect orders with the cost of circuit connection orders, or the early contractual termination fees with the cost of new technology.

13. The method of claim 8, wherein the calculating the amount of cost savings includes subtracting a cost of the telecommunications infrastructure in the second configuration over a time period from a cost of the telecommunications infrastructure in the first configuration over the time period.

14. The method of claim 8, wherein the calculating the return-on-investment timeframe is based on the amount of cost savings and the upfront costs.

15. A method, comprising:
generating a predictive model configured to predict a business impact of migration from a telecommunications infrastructure in a first configuration to the telecommunications infrastructure in a second configuration, the predictive model having calculated data that is based on a data associated with the telecommunications infrastructure in the first configuration and data associated with the telecommunications infrastructure in the second configuration, the calculated data including at least one of upfront costs associated with the migration, a return-on-investment timeframe associated with the migration, or an amount of cost savings associated with the migration; and
sending an output associated with the predictive model to an output module configured to display the output, the output including a representation of a prediction of the business impact based on the calculated data.

16. The method of claim 15, wherein the output is displayed in at least one of a graphical format, a tabular format, or a spreadsheet format.

17. The method of claim 15, wherein the telecommunications infrastructure in the first configuration is associated with a telecommunications infrastructure at a first time and the telecommunications infrastructure in the second configuration is associated with a telecommunications infrastructure at a second time later than the first time.

18. The method of claim 15, wherein the calculated data includes at least one of a cost analysis, a performance-against-industry benchmark analysis, or a data representation of a physical network diagram of the telecommunications infrastructure in the second configuration.

19. The method of claim 15, wherein the data associated with the telecommunications infrastructure in the second configuration is associated with user-selected telecommunications infrastructure criteria including at least one of a service provider identifier, a service identifier, a wireless device identifier, a total number of circuits to be converted, a total number of circuits to be converted per month, a total number of wireless users to be converted, a conversion start date, or an industry benchmark.

20. A method, comprising:
receiving telecommunications industry benchmark information and infrastructure data for a telecommunications infrastructure;
calculating performance data associated with the telecommunications infrastructure at a first time and performance data associated with the telecommunication infrastructure at a second time based on the infrastructure data; and
sending an indicator of the performance data associated with the telecommunications infrastructure at a first time, an indicator of the performance data associated with the telecommunication infrastructure at a second time, and an indicator of the industry benchmark information such that the industry benchmark information and at least one of the performance data associated with the telecommunications infrastructure at a first time and performance data associated with the telecommunication infrastructure at a second time are compared.

21. The method of claim 20, further comprising:
sending a trend indicator based on the performance data associated with for the telecommunications infrastructure at a first time and performance data associated with the telecommunication infrastructure at a second time based on the infrastructure data.
